(19) United States
(12) Patent Application Publication
(10) Pub. No.: US 2018/0156369 A1
(43) Pub. Date: Jun. 7, 2018

(54) COMPLIANT FLEXURAL INNER SHROUD FOR BELLOWED SPHERICAL FLEX-JOINT ASSEMBLIES FOR REDUCED DYNAMIC ROTATIONAL STIFFNESS

(71) Applicant: Unison Industries LLC, Jacksonville, FL (US)

(72) Inventors: Gordon TAJIRI, Dayton, OH (US); Michael Thomas KENWORTHY, Beavercreek, OH (US); Douglas MILLWARD, Dayton, OH (US); Lonnie Ray STEWART, Jr., Dayton, OH (US)

(21) Appl. No.: 15/579,200

(22) PCT Filed: May 4, 2016
(86) PCT No.: PCT/US2016/030724

§ 371 Date: Dec. 2, 2017

Related U.S. Application Data
(60) Provisional application No. 62/190,528, filed on Jul. 9, 2015.

(51) Int. Cl. F16L 27/073; F01D 9/06; F01D 11/00; F02C 6/08; F16L 51/02

(52) U.S. Cl. CPC F16L 27/073; F01D 9/06; F05D 2220/323; F02C 6/08; F16L 51/025; F01D 11/005

(57) ABSTRACT

A turbine engine duct assembly and joint assembly having an outer shroud at least partially defining an interior of the joint assembly, an inner shroud at least partially received within the outer shroud and forming an interface therewith and defining a remainder of the interior of the joint assembly and having a flexible portion for dynamic movement of the duct assembly during operation of the engine.

### CROSS-REFERENCE TO RELATED APPLICATION

This application claims priority from U.S. Provisional Application No. 62/190,484 filed on Jul. 9, 2015, entitled Flexural Spring-Energized Interface for Bellowed Ball-Joint Assemblies for Controlled Rotational Constraint and U.S. Provisional Application No. 62/190,528 filed on Jul. 9, 2015, entitled Compliant Flexural Inner Shroud for Bellowed Spherical Flex-Joint Assemblies for Reduced Dynamic Rotational Stiffness which are incorporated herein by reference in their entirety.

### BACKGROUND OF THE INVENTION

Turbine engines, and particularly gas or combustion turbine engines, are rotary engines that extract energy from a flow of combusted gases passing through the engine in a series of compressor stages, which include pairs of rotating blades and stationary vanes, through a combustor, and then onto a multitude of turbine stages, also including multiple pairs of rotating blades and stationary vanes.

Duct assemblies are provided about the turbine engine and provide conduits for the flow of various operating fluids to and from the turbine engine. One of the operating fluids is bleed air. In the compressor stages, bleed air is produced and taken from the compressor via feeder ducts. Bleed air from the compressor stages in the gas turbine engine can be utilized in various ways. For example, bleed air can provide pressure for the aircraft cabin, keep critical parts of the aircraft ice-free, or can be used to start remaining engines. Configuration of the feeder duct assembly used to take bleed air from the compressor requires rigidity under dynamic loading, and flexibility under thermal loading. Current systems use ball joints or axial joints in the duct to meet requirements for flexibility, which compromise system dynamic performance by increasing the weight of the system.

### BRIEF DESCRIPTION OF THE INVENTION

In one aspect, various aspects described herein relate to a bleed air duct assembly having a first duct, a second duct, and a joint assembly coupling the first duct to the second duct and including an outer shroud at least partially defining an interior of the joint assembly, an inner shroud at least partially received within the outer shroud and forming an interface therewith and defining a remainder of the interior of the joint assembly, where the inner shroud includes a set of slits defining a set of flexures, which are located at the interface, and a bellows disposed interiorly of the outer shroud and inner shroud and fluidly coupling the first duct and the second duct.

In another aspect, various aspects described herein relate to a joint assembly having an outer shroud at least partially defining an interior of the joint assembly, an inner shroud at least partially received within the outer shroud and forming an interface therewith and defining a remainder of the interior of the joint assembly, where the inner shroud includes a flexible portion at the interface, and a bellows assembly disposed interiorly of the outer shroud and inner shroud.

### BRIEF DESCRIPTION OF THE DRAWINGS

In the drawings:

FIG. 1 is a schematic cross-sectional view of a gas turbine engine with a bleed air ducting assembly.

FIG. 2 is a perspective view of the bleed air ducting assembly having multiple joint assemblies.

FIG. 3 is a perspective view of an exemplary joint assembly that can be utilized in the air ducting assembly of FIG. 2

FIG. 4 is a cross-sectional view of the joint assembly of FIG. 3.

FIG. 5 is a perspective view of a portion of an inner shroud and a portion of an outer shroud of the joint assembly of FIG. 3.

FIGS. 6 and 7 are different perspective views of the inner shroud of FIG. 3.

### DESCRIPTION OF EMBODIMENTS OF THE INVENTION

The aspects of the disclosure herein are directed to providing a bellowed flex-joint for reduced reaction loading into the fan case of turbine engines during assembly and thermal growth of high-temperature bleed-air ducting systems. More specifically, current designs can have high rotational stiffness due to different pressure magnitudes in the joint because of various process artifact effects. Flexure modifications to the inner shroud are dynamically compliant during rotation with a non-conforming outer shroud surface. The flexures can uniformly distribute loads at the kinematic interface between the inner and outer shrouds.

For purposes of illustration, the present invention will be described with respect to an aircraft gas turbine engine. Gas turbine engines have been used for land and nautical locomotion and power generation, but are most commonly used for aeronautical applications such as for airplanes, including helicopters. In airplanes, gas turbine engines are used for propulsion of the aircraft. It will be understood, however, that the invention is not so limited and can have general applicability in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine relative to the engine centerline. Additionally, as used herein, the terms “radial” or “radially” refer to a dimension extending between a center longitudinal axis of the engine and an outer engine circumference.

All directional references (e.g., radial, axial, proximal, distal, upper, lower, upward, downward, left, right, lateral, front, back, top, bottom, above, below, vertical, horizontal, clockwise, counterclockwise, upstream, downstream, aft, etc.) are only used for identification purposes to aid the reader's understanding of the present invention, and do not create limitations, particularly as to the position, orientation, or use of the invention. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. The exemplary drawings are for purposes of illustration only and the dimensions, positions, order and relative sizes reflected in the drawings attached hereto can vary.

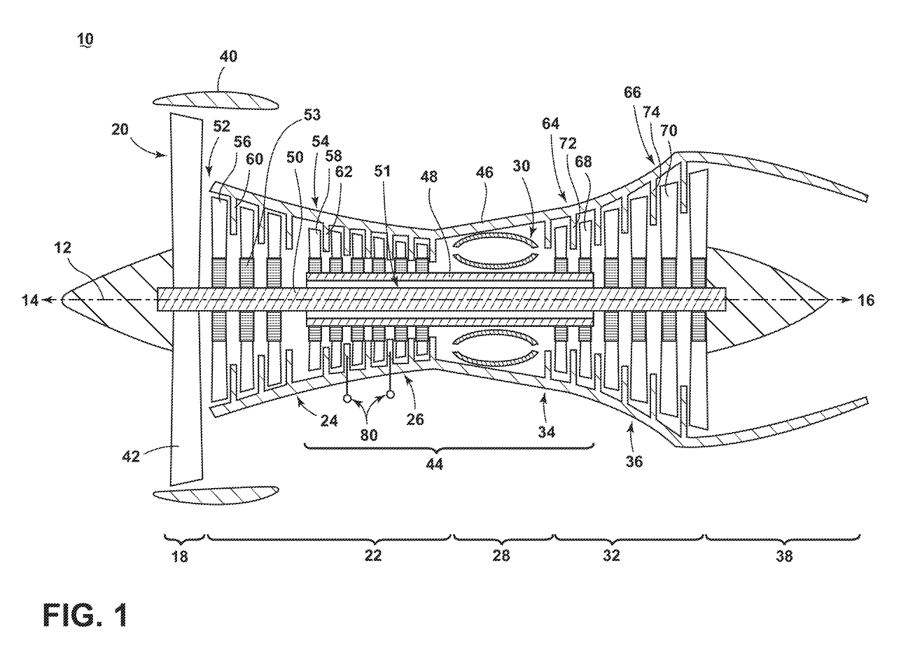

FIG. 1 is a schematic cross-sectional diagram of a gas turbine engine 10 for an aircraft. The engine 10 has a generally longitudinally extending axis or centerline 12 extending from forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The portions of the engine 10 mounted to and rotating with either or both of the spools 48, 50 are also referred to individually or collectively as a rotor 51.

The LP compressor 24 and the HP compressor 26 respectively include a plurality of compressor stages 52, 54, in which a set of compressor blades 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible. The blades 56, 58 for a stage of the compressor can be mounted to a disk 53, which is mounted to the corresponding one of the HP and LP spools 48, 50, respectively, with each stage having its own disk. The vanes 60, 62 are mounted to the core casing 46 in a circumferential arrangement about the rotor 51.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in the combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

Some of the air from the compressor section 22 can be bled off via one or more bleed air duct assemblies 80, and be used for cooling of portions, especially hot portions, such as the HP turbine 34, and/or used to generate power or run environmental systems of the aircraft such as the cabin cooling/heating system or the deicing system. In the context of a turbine engine, the hot portions of the engine are normally downstream of the combustor 30, especially the turbine section 32, with the HP turbine 34 being the hottest portion as it is directly downstream of the combustion section 28. Air that is drawn off the compressor and used for these purposes is known as bleed air.

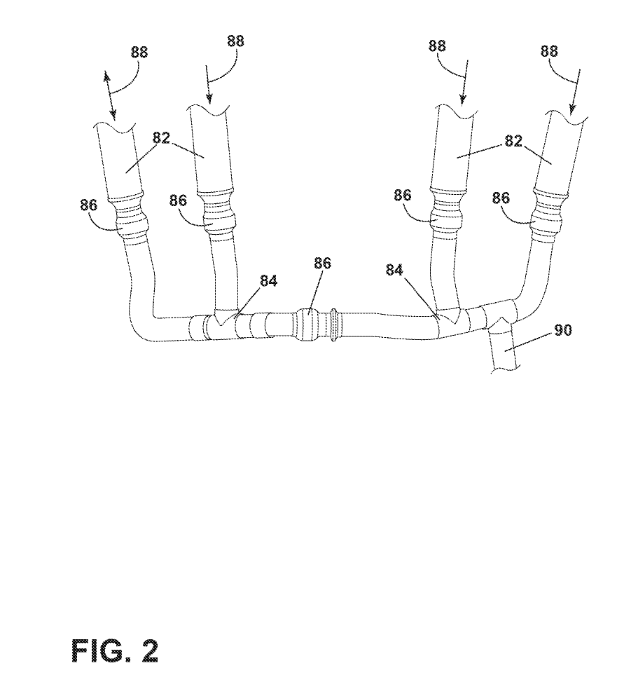

Referring to FIG. 2, an exemplary bleed air duct assembly 80 includes radially inner first ducts 82 and radially outer second ducts 84. The first and second ducts 82, 84 can be fixed in their position. A joint assembly 86, which can include, but is not limited to, a ball-joint, axial joint, etc. couples the first and second ducts 82, 84. A flow of bleed air 88 can be drawn from the compressor section 22 into the first ducts 82, through the second ducts 84, and provided to an exhaust duct 90 for use in various other portions of the engine 10 or aircraft. The flow of bleed air 88 can act to heat and expand portions of the bleed air duct assembly 80. As the first and second ducts 82, 84 can be fixed the joint assembly 86 provides for reducing or mitigating forces acting on the bleed air duct assembly 80 such as vibration or thermal expansion, while providing for operational flexion of the bleed air duct assembly 80.

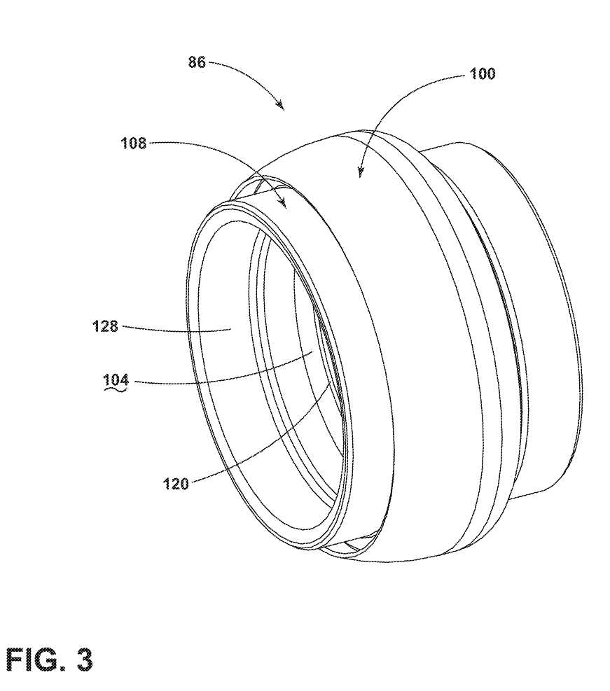

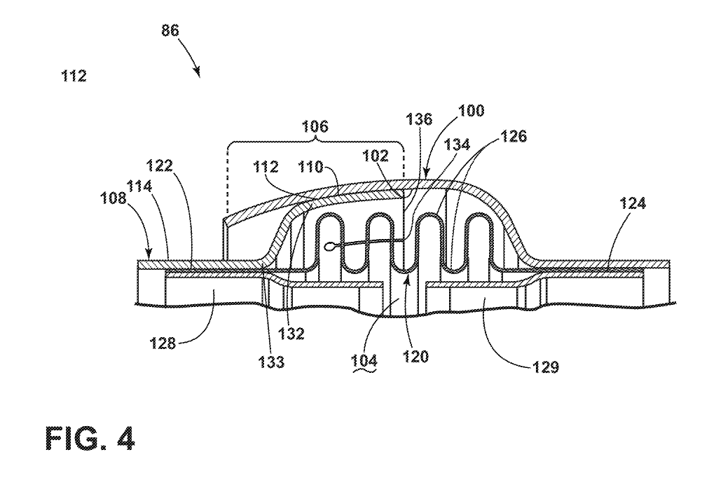

FIG. 3 illustrates an exemplary joint assembly 86 having an outer shroud 100 and an inner shroud 108. The joint assembly 86 can be utilized to fluidly couple desired first and second ducts, including those of FIG. 2. The exemplary joint 86 is a ball joint and is shown in more detail in the cross-sectional view of FIG. 4. More specifically, a rounded casing or outer shroud 100 is illustrated as including an inner surface 102 that at least partially defines a joint interior 104. The outer shroud 100 can be a single integral piece, or can be a combination of multiple pieces to form the annular shroud 100. A portion 106 of an inner shroud 108 is located radially interior of the inner surface 102 and further defines the joint interior 104. An exterior surface 110 of the inner shroud 108 abuts the inner surface 102 of the outer shroud 100 to form an interface 112. A remainder 114 of the inner shroud 108 can extend beyond the outer shroud 100.

A bellows assembly or bellows 120 is disposed within the joint interior 104 radially interior of both the outer shroud 100 and the inner shroud 108. The bellows 120 has a first end 122 spaced from a second end 124. A number of convolutions 126 can be included between the first end 122 and the second end 124. While the convolutions 126 have been illustrated as having a sinusoidal profile this need not be the case. The bellows 120 can be formed from a flexible material and the convolutions 126 therein can permit expansion or contraction of the bellows 120.

The bellows 120 can be held in position within the joint interior 104 in any suitable manner including, but not limited to, a first fitting 128 and a second fitting 129. The first fitting 128 and the second fitting 129 can be interference fit, press fit, or otherwise mounted within the joint assembly 86. In the illustrated example, the first fitting 128 retains the first end 122 of the bellows 120 within the inner shroud 108 and the second fitting 129 retains the second end 124 of the bellows 120 within the outer shroud 100. It will be understood that the joint assembly 86 can be mounted or otherwise operably coupled to first and second ducts, such as the first and second ducts 82, 84 of FIG. 2, in any suitable manner including utilizing the first fitting 128 and the second fitting 129 or additional or alternative coupling mechanisms.

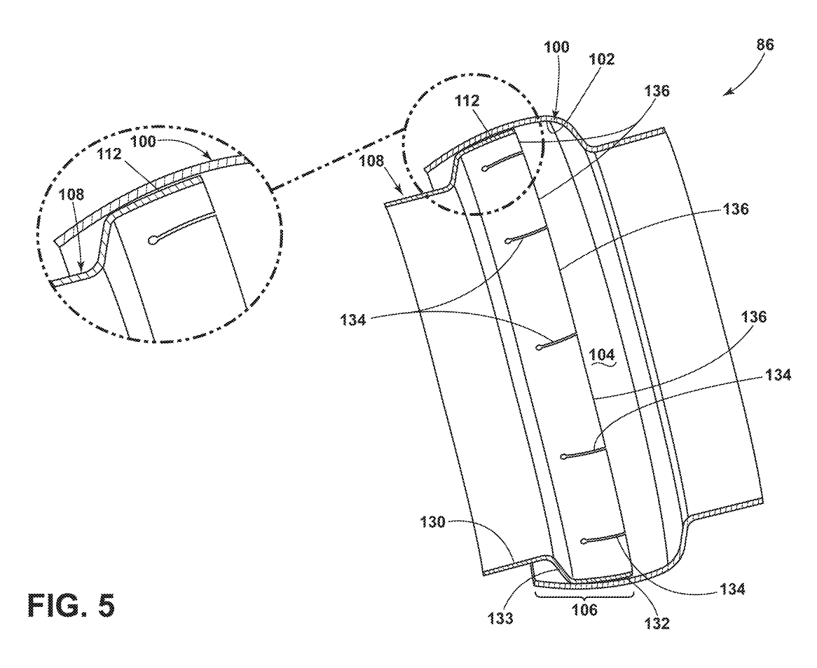

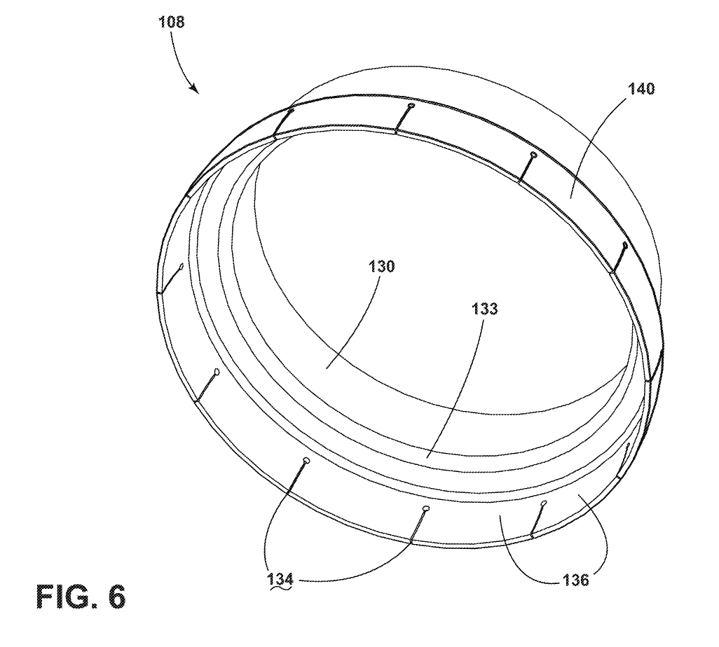

FIG. 5 shows a cross-section of a portion of the inner shroud 108 received within a portion of the outer shroud 100 and with the remaining portions of the joint assembly 86 removed. The inner shroud 108 can be separated into a longitudinal portion 130 and a flared portion 132. The longitudinal portion 130 and the flared portion 132 can include a transition portion 133, which connects the longitudinal portion 130 to the flared portion 132. The inner shroud 108 can include a flexible portion that is located at the interface 112. It will be understood that portions of the outer shroud 100 and the inner shroud 108, including at the interface 112, can be spherical or relatively spherical with slight out-of-roundness and the flexible portion can aid in accounting for such out-of-roundness. In the illustrated example, the flared portion 132 includes a set of slits 134 which define a set of flexures 136 disposed along the inner shroud 108 at the interface 112. It will be understood that “a set” can include any number, including only one. Such flexures 136 can define the flexible portion of the inner shroud 108. Additionally, the set of slits 134 can include a set of slots or apertures to define the set of flexures 136. The slits 134 can extend partially or fully along a length of the flared portion 132 or even into the transition portion 133 or the longitudinal portion 130 to define flexures 136 of predetermined lengths. While the flexures 136 are illustrated as evenly spaced along the entire flared portion 132 (See FIG. 6), it is also contemplated that the flexures 136 can be unevenly spaced or designed to be larger, smaller, wider, thinner, have similar or dissimilar lengths, or otherwise oriented to adapt to the particular needs of the particular joint assembly 86.

While the inner shroud 108 has been illustrated as a continuous inner shroud, it will be understood that the inner shroud 108 can alternatively be disjointed or can include multi-pieces. By way of further non-limiting example, the inner shroud 108 can be formed from multiple arcuate pieces. Such arcuate pieces can be operably coupled together.

Frictional forces are present between the outer shroud 100 and the inner shroud 108 at their interface 112 due to out-of-roundness errors created during manufacturing, local surface imperfections, and asymmetric thermal growth distortions during operation. These distortions and imperfections are difficult to quantify and control during the manufacturing process and can create gaps at the interface, which can cause uneven distribution of the interfacial loading and vibration within the system. The macro-level distortions and micro-level imperfections dynamically alter the surface interaction geometry at the interface between the inner shroud 108 and the outer shroud 100, affecting local wear and friction. The dynamic load and temperature dependent changes are unique for each assembly and can be difficult to measure and predict.

During the forming process of the outer shroud 100 over the inner shroud 108 a residual interface pre-load can be developed. The residual pre-load is stored during the flexing of the flared tube 120 that is loaded during the forming of the outer shroud 100. When the forming load for the outer shroud is removed, the flared tube 120 will spring back to load the kinematic ring 128 against the inner surface 102 of the outer shroud 100. The magnitude of this load is dependent on the forming die geometry and the associated pre-load of the inner shroud geometry. Additionally, the developed thrust load and operating geometry of the bellows 120 are related to the operating differential pressure and thermal growth. Such a geometry can be used during the die-forming process to drive the kinematic ring 128 into the flared tube 120. The spring elements of the flared tube 120 are pre-loaded to maintain contact between the kinematic ring 128 and the inner surface 102 of the outer shroud 100. This interaction creates a zero-backlash interface.

With the use of similar thermal growth materials at the interface 112, the differential pressure load dominates these effects. As the bellows 120 expands axially, the thrust load on the interface 112 increases. Surface imperfections and forming distortion errors also contribute to the overall surface interface loads. The total interface load is a combination of these effects and directly contributes to the interface friction.

During operation, vibration or thermal expansion can cause movement of components of the joint assembly 86 including compression or expansion of the bellows 120. The bellows 120 provides for movement and flexion of the bleed air duct assembly 80 where excessive system rigidity would otherwise lead to damage or malfunction of the duct assembly 80. The bellows 120, however, does not provide for additional macro-level distortions and micro-level imperfections such as the magnitude of frictional forces between the outer shroud 100 and the inner shroud 108, roundness error of the outer shroud 100 and the inner shroud 108 during manufacture, local surface imperfections, or asymmetric thermal growth of the joint assembly 86.

The flexures 136 reduce the maximum frictional forces between outer shroud 100 and the inner shroud 108 due to out of roundness errors during manufacturing processes, local surface imperfections, and asymmetric thermal growth distortions of the outer shroud 100 or the inner shroud 108. The flexible portion of the inner shroud 108, specifically the flexures 136 described herein, provides for a dynamically compliant interface surface to account for these macro-level shape distortions and micro-level surface features. The compliant flexures 136 add independent, dynamically altering interface features that continually conform at the interface 112 between the outer shroud 100 and the inner shroud 108. Concentrated peak surface contact loads are reduced and distributed and shared with the others flexures 136. Further, the rotational stiffness of the joint assembly 86 is reduced.

The flexures 136 can operate as a biasing element, or a spring, to kinematically constrain and dynamically conform to the interface 112 between the outer shroud 100 and the inner shroud 108. For example, the flexures 136 can operate as discrete springs which can flex based upon the local movement or growth of the joint assembly 86 based upon the macro-level and micro-level distortions and imperfections. As such, the inner shroud 108 can dynamically conform to local changes of the joint assembly 86 during operation and the flexures 136 reduce rotational or torsional stiffness of the duct assembly 80, providing for greater variable movement at the joint assembly 86.

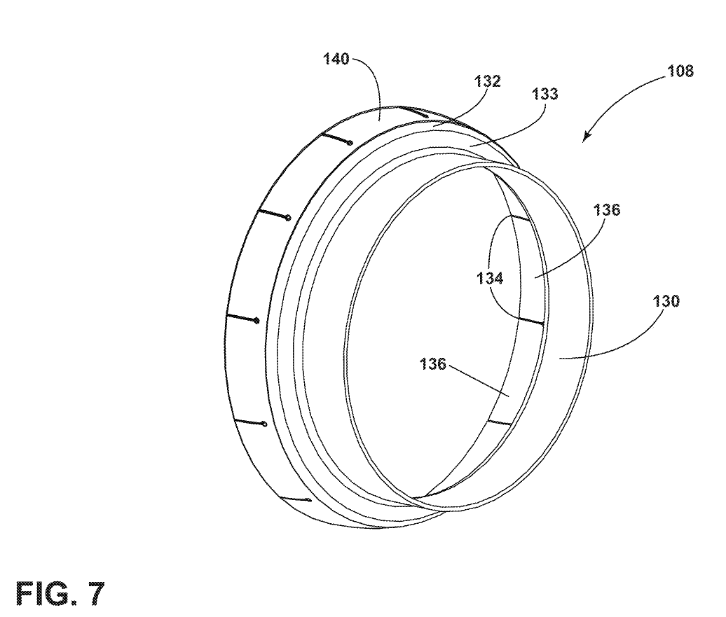

Furthermore, the flexures 136 minimize the residue interface mismatch of the two mating surfaces between the inner shroud 108 and the outer shroud 100. The joint assembly 86 can be optimized for high-cycle fatigue. The macro-level shape of the inner shroud 108 can be precisely controlled including, but not limited to, that the total indicated runout (TIR) can be less than 0.127 millimeters (0.005 inches) and the surface will be finished to a roughness of, by way of non-limiting example, less than 16 uin. The coefficient of friction is directly related to the surface roughness. For instance, the addition of a suitable surface treatment can be used to further reduce the coefficient of friction. Additionally or alternatively, a conforming and compliant interface die-formed laminate pad made from graphite foil and impregnated wire mesh can be fixed to the interface surfaces of the flexures 136. FIG. 7 further illustrates that such a pad or surface treatment 140 can be included on a portion of the inner shroud 108. Alternatively, the pad or surface treatment could be provided on at least a portion of the outer shroud 100.

The above disclosure provides a variety of benefits including that a bellowed joint that adds compliance to account for geometric process variability and surface interface mismatch can be provided. The inclusion of the independent flexural elements along the expanded perimeter of the inner shroud alleviates most of the process artifact effects and the maximum direct rotational stiffness coupling effects due to differential pressure magnitudes. Uniformity of the interface pressure load distribution is increased and high localized surface loads and associated friction forces are minimized. The coefficient of friction at the interface can be reduced utilizing surface treatments or additional pads of material at the interface.

To the extent not already described, the different features and structures of the various embodiments can be used in combination with each other as desired. That one feature is not illustrated in all of the embodiments is not meant to be construed that it cannot be, but is done for brevity of description. Thus, the various features of the different embodiments can be mixed and matched as desired to form new embodiments, whether or not the new embodiments are expressly described. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A bleed air duct assembly for a gas turbine engine, comprising:
a first duct;
a second duct; and
a joint assembly coupling the first duct to the second duct and comprising:
an outer shroud at least partially defining an interior of the joint assembly,
an inner shroud at least partially received within the outer shroud and forming an interface therewith and defining a remainder of the interior of the joint assembly, where the inner shroud includes a set of slits defining a set of flexures, which are located at the interface; and
a bellows disposed interiorly of the outer shroud and inner shroud and fluidly coupling the first duct and the second duct.

2. The bleed air duct assembly of claim 1 wherein the inner shroud further comprises a flared portion and the set of slits extend along a portion of the length of the flared portion.

3. The bleed air duct assembly of claim 2 wherein the flexures are evenly spaced.

4. The bleed air duct assembly of claim 2 wherein the inner shroud further comprises transition portion and a longitudinal portion.

5. The bleed air duct assembly of claim 4 wherein the set of slits extends through the length of the flared portion and into the transition portion.

6. The bleed air duct assembly of claim 1 wherein the set of slits form flexures of different lengths.

7. The bleed air duct assembly of claim 1, further comprising at least one fitting mounting the bellows within the interior of the joint assembly.

8. The bleed air duct assembly of claim 1 wherein the joint assembly is a ball joint assembly.

9. The bleed air duct assembly of claim 1 wherein the outer shroud and the inner shroud are spherical at the interface.

10. A joint assembly, comprising:
an outer shroud at least partially defining an interior of the joint assembly,
an inner shroud at least partially received within the outer shroud and forming an interface therewith and defining a remainder of the interior of the joint assembly, where the inner shroud comprises a flexible portion at the interface; and
a bellows assembly disposed interiorly of the outer shroud and inner shroud.

11. The joint assembly of claim 10 wherein the flexible portion comprises a set of evenly spaced slits included in the inner shroud and defining a set of flexures located at the interface.

12. The joint assembly of claim 11 wherein the flexures are configured to uniformly distribute loads at the interface between the inner shroud and the outer shroud.

13. The joint assembly of claim 11 wherein the inner shroud comprises multiple arcuate pieces operably coupled together.

14. A joint assembly, comprising:
an outer shroud at least partially defining an interior of the joint assembly,
an inner shroud at least partially received within the outer shroud and forming an interface therewith and defining a remainder of the interior of the joint assembly, where the inner shroud includes a set of slits defining a set of flexures, which are located at the interface; and
a bellows assembly disposed interiorly of the outer shroud and inner shroud.

15. The joint assembly of claim 14 wherein the inner shroud further comprises a flared portion that forms an interface with the outer shroud and the set of slits extend along a portion of the length of the flared portion.

16. The joint assembly of claim 15 wherein the inner shroud further comprises a longitudinal portion that extends past the outer shroud and a transition portion between the longitudinal portion and the flared portion.

17. The joint assembly of claim 16 wherein the set of slits extends through the length of the flared portion and into the transition portion.

18. The joint assembly of claim 14 wherein the flexures are evenly spaced.

19. The joint assembly of claim 14, further comprising at least one fitting mounting the bellows assembly within the interior of the joint assembly.

20. The joint assembly of claim 14 wherein the outer shroud and the inner shroud are relatively spherical at the interface.
